(19) United States
(12) Patent Application Publication
(10) Pub. No.: US 2017/0343051 A1
(43) Pub. Date: Nov. 30, 2017

(54) POWER TRANSMISSION SHAFT

(71) Applicant: IONES CO., LTD., HWASEONG-SI (KR)

(72) Inventors: MUN KI LEE, SUWON-SI (KR); JAE DEOK KO, SEOUL (KR); KEUM MO KIM, CHEONAN-SI (KR); SOON JONG SONG, SEOUL (KR); JI MAN LEE, SUWON-SI (KR); YOUNG WON CHOI, SEOUL (KR); JEONG CHAN LEE, SEOUL (KR); JIN HO PARK, SEOUL (KR); BYUNG GI KIM, SUWON-SI (KR)

(21) Appl. No.: 15/536,652

(22) PCT Filed: Mar. 3, 2015
(86) PCT No.: PCT/KR2015/002009

§ 371 Date: Jun. 16, 2017

(30) Foreign Application Priority Data
Dec. 30, 2014 (KR) 10-2014-0193167

(51) Int. Cl. F16D 3/78; F16C 3/02

(52) U.S. Cl. CPC F16D 3/78; F16C 3/02

(57) ABSTRACT

A power transmission shaft which alleviates phenomenon in which stress is concentrated on a specific portion of a diaphragm to improve fatigue life span. The power transmission shaft connects a power apparatus and includes a flexible coupling, which is configured by a hub unit positioned inside in a radial direction. A rim unit is positioned outside in a radial direction of the hub unit. A flexible diaphragm unit is positioned between the hub unit and the rim unit. The thickness in the axial direction of the flexible diaphragm unit, from the hub unit toward the rim unit, becomes thinner then thicker to have a minimum thickness interval. The flexible diaphragm unit has a contoured first side on one side in the axial direction and a contoured second side on the other side. The first side has a first inflection point and the second side has a second inflection point.

### TECHNICAL FIELD

The present invention relates to a power transmission shaft, and more particularly, to a power transmission shaft which is connected between an engine and a gear box of an aircraft to transmit power.

### BACKGROUND ART

In general, a coupling is a shaft connection device for connecting a driven shaft to a driving shaft, and there are various couplings, such as fluid couplings, gear couplings, flexible couplings, and so on, according to their types. Moreover, a user selects a coupling of a proper type in consideration of an optimal torque range, torsional strength, eccentric error absorption, proper number of revolutions, and so on according to use purposes.

As an example, in the case of aircrafts, a power transmission shaft is mounted between an engine and a gear box to transmit power of the engine to the gear box. In this instance, because vibration and shock are generated due to the nature of aircrafts, a flexible coupling is used in order to absorb such vibration and shock and continuously transmit power of the engine to the gear box even though an axial center becomes eccentric among the engine, the power transmission shaft and the gear box. Such a flexible coupling is rigid in the rotational direction but is soft in the axial direction.

U.S. Pat. No. 4,802,882 discloses a flexible coupling. The conventional flexible coupling includes a first joint part connected with a power transmission shaft, a second joint part connected with a device (an engine or a gear box), and a diaphragm arranged between the first joint part and the second joint part to connect the first joint part and the second joint part with each other in a communicating manner.

The diaphragm has a plurality of diaphragm members mounted between the first joint part and the second joint part to connect the first and second joint parts to communicate with each other in an axial direction. The flexible coupling can absorb vibration and shock generated from an aircraft and transmit power of the engine to the gear box even though an axial center becomes eccentric among the engine, the power transmission shaft and the gear box.

U.S. Pat. No. 8,591,345 discloses a flexible diaphragm coupling for axial force loads. FIG. 1 is a sectional view showing a conventional flexible coupling assembly, and FIG. 2 is a sectional view showing a conventional diaphragm coupling element.

As shown in FIG. 1, the diaphragm element 10 includes a hub unit 12 located at a radially inner portion, a rim unit 14 located at radially outer portion, and a flexible diaphragm unit 16 located between the hub unit 12 and the rim unit 13. The flexible diaphragm unit 16 is formed to get thinner from the hub unit 12 to the rim unit 14 and get wider from the rim unit 14. That is, the flexible diaphragm unit 16 has the minimum thickness Tmin at the rim unit. The flexible diaphragm unit 16 includes a first side 22, which is contoured at one side, and a second side 24, which is planar and is formed at the other side.

Referring to FIG. 2, the flexible coupling assembly 200 is connected between two driving shafts. The flexible coupling assembly 200 includes a first flange 202 connected with a first shaft and a second flange 204 connected with a second shaft. Moreover, the flexible coupling assembly 200 includes a first flexible diaphragm element 210, a second diaphragm element 212, a third diaphragm element 214 and a fourth diaphragm element 216.

The first and second flexible diaphragm elements 210 and 212 are arranged in such a way that the contoured surfaces face the first flange 202, and the third and fourth flexible diaphragm elements 214 and 216 are arranged in such a way that the contoured surfaces face the second flange 204.

That is, the conventional flexible coupling assembly 200 has a structure that one side of the diaphragm is planar and the other side has one inflection point 23 in the axial direction. In this instance, the conventional flexible coupling assembly 200 has the minimum thickness Tmin at the inflection point 23 of the diaphragm.

However, the conventional flexible coupling assembly 200 is disadvantageous in that it is weak to fatigue because stress is concentrated at the inflection point 23 when the diaphragm is bent. Finally, in the case that the flexible couplings having the contoured diaphragms are applied to both sides of the power transmission shaft for transmitting power, the lifespan of the power transmission shaft is closely connected with improvement of fatigue life of the flexible coupling. Therefore, the structure of the conventional flexible coupling assembly having just one inflection point may shorten the lifespan of the power transmission shaft.

### DISCLOSURE

### Technical Problem

Accordingly, the present invention has been made in view of the above-mentioned problems occurring in the prior art, and it is an object of the present invention to provide a power transmission shaft, which can alleviate the phenomenon in which stress is concentrated on a specific portion of a diaphragm, thereby improving fatigue life.

### Technical Solution

To accomplish the above object, according to the present invention, there is provided A power transmission shaft for connecting a power apparatus, which includes a flexible coupling having a hub unit located inside in a radial direction, a rim unit located outside in the radial direction of the hub unit, and a flexible diaphragm unit located between the hub unit and the rim unit, wherein the flexible diaphragm unit has a minimum thickness section at between the hub unit and the rim unit, and the flexible diaphragm unit comprises a first contoured side at one side and a second contoured side at the other side in an axial direction, and the first side has a first inflection point and the second side has a second inflection point, and the flexible diaphragm unit has section shape getting narrower from the hub unit to the second inflection point and getting wider from the first inflection point to the rim unit, and the first inflection point is formed at a different position in a radial direction relative to the second inflection point.

### Advantageous Effects

As described above, the power transmission shaft according to an embodiment of the present invention can alleviate the phenomenon in which stress is concentrated on a specific portion of a diaphragm, thereby improving fatigue properties of the diaphragm and extending the lifespan of the power transmission shaft.

### DESCRIPTION OF DRAWINGS

FIG. 1 is a sectional view showing a conventional flexible coupling assembly.

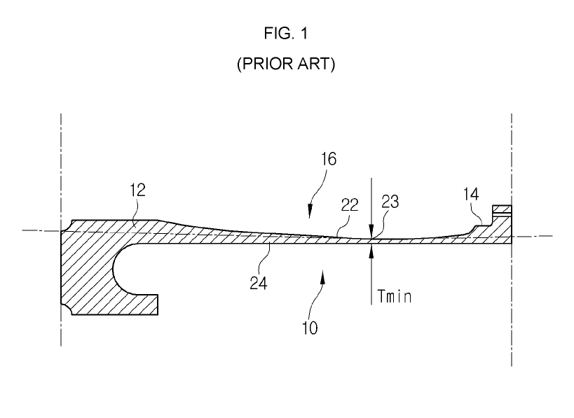

FIG. 2 is a sectional view showing a conventional diaphragm coupling element.

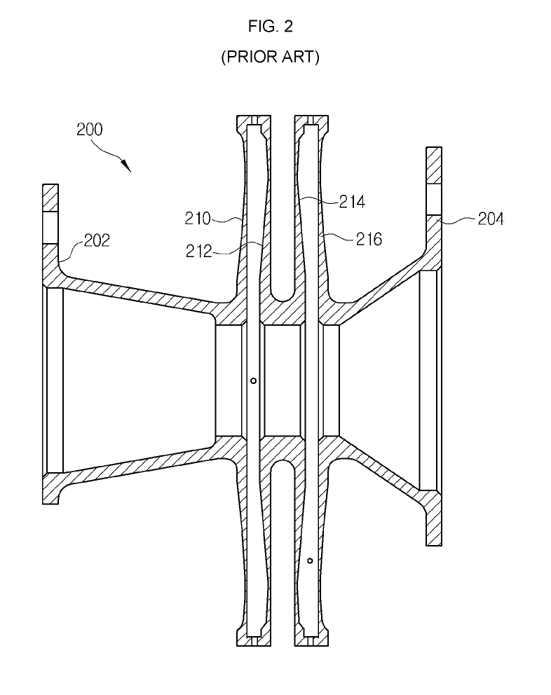

FIG. 3 is a front view schematically showing a power transmission shaft according to a preferred embodiment of the present invention.

FIG. 4 is a sectional view of the power transmission shaft according to the preferred embodiment of the present invention.

FIG. 5 is a sectional view showing a flexible coupling of the power transmission shaft according to the preferred embodiment of the present invention.

FIG. 6 is an enlarged sectional view of FIG. 5.

### MODE FOR INVENTION

Hereinafter, reference will be now made in detail to the technical construction of a power transmission shaft with reference to the attached drawings.

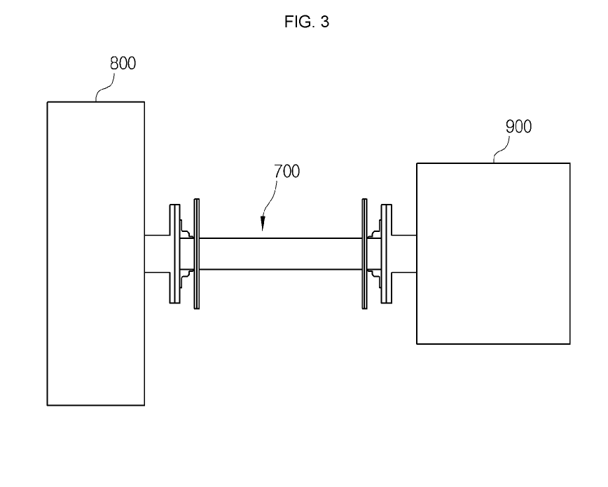

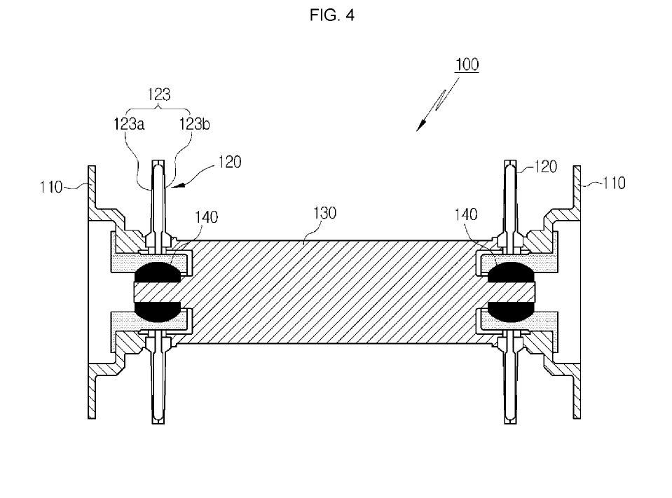

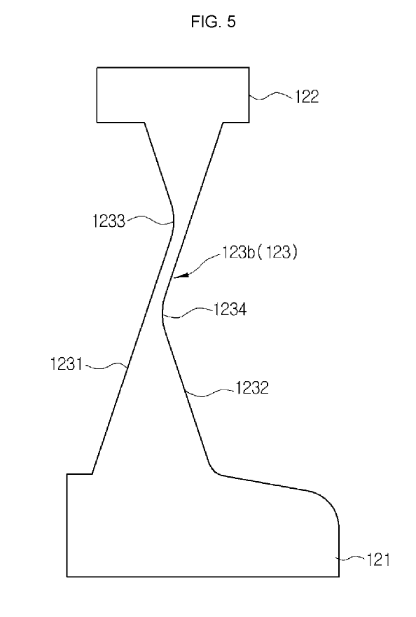

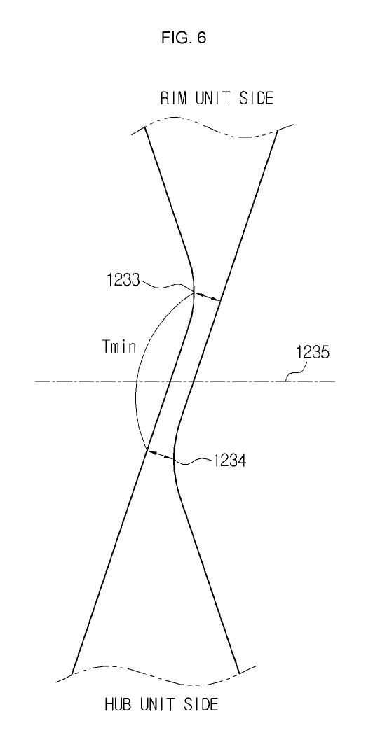

FIG. 3 is a front view schematically showing a power transmission shaft according to a preferred embodiment of the present invention, FIG. 4 is a sectional view of the power transmission shaft according to the preferred embodiment of the present invention, FIG. 5 is a sectional view showing a flexible coupling of the power transmission shaft according to the preferred embodiment of the present invention, and FIG. 6 is an enlarged sectional view of FIG. 5.

In the following description, the lateral direction of FIG. 4 is an “axial direction” and the vertical direction is a “radial direction”.

As shown in FIGS. 3 to 6, the power transmission shaft 100 according to the preferred embodiment of the present invention connects an engine 800 and a gear box 900 of an aircraft with each other to transmit power. The power transmission shaft 100 includes: a main shaft 130 for connecting a power apparatus; flanges 110 disposed at both sides of the main shaft 130 to be joined with the power apparatus; and a flexible coupling 120 formed to extend in a radial direction of the main shaft 130. Moreover, the power transmission shaft 100 may include a ball joint 140 which is whirling preventing means.

The flexible coupling 120 includes a hub unit 121, a rim unit 122 and a flexible diaphragm unit 123.

The hub unit 121 is located at a radially inner portion, and may be joined between the flange 110 and the main shaft 130 by welding. The rim unit 122 is located at a radially outer portion of the hub unit 121. The flexible diaphragm unit 123 is located between the hub unit 121 and the rim unit 122.

The flexible diaphragm unit 123 gets smaller in an axial thickness from the hub unit 121 to the rim unit 122 so as to have the minimum thickness section Tmin at the rim unit 122. Moreover, the flexible diaphragm unit 123 includes a first contoured side 1231 at one side and a second contoured side 1232 at the other side in an axial direction. That is, the flexible diaphragm unit 123 has continuously streamlined surfaces at both sides in the axial direction.

Furthermore, the first side 1231 has a first inflection point 1233, the second side 1232 has a second inflection point 1234, and the first inflection point 1233 is formed at a position different from the second inflection point 1234 in the radial direction. That is, one of the first inflection point 1233 and the second inflection point 1234 is arranged outside in the radial direction relative to the other one.

Referring to FIG. 6, on the basis of a central line 1235 between the first inflection point 1233 and the second inflection point 1234 in the radial direction, a section between the first inflection point 1233 and the central line 1235 and a section between the second inflection point 1234 and the central line 1235 are formed symmetrically. In other words, the minimum thickness Tmin is formed to extend from the first inflection point 1233 to the second inflection point 1234, such that the section having the minimum thickness is elongated to a predetermined length.

In more detail, the first inflection point 1233 is formed is formed at a position different from the second inflection point 1234 in the radial direction, and the first side 1231 and the second side 1232 are formed in such a way that the radial outside of the first inflection point 1233 and the radial inside of the second inflection point 1234, except the rim unit 122 and the hub unit 121, are symmetric to each other relative to the central surface. The first inflection point 1233 and the second inflection point 1234 have the minimum thickness, and the minimum thickness section is formed because the first inflection point 1233 and the second inflection point 1234 are formed continuously, so as to disperse stress.

Furthermore, if a straight section formed by a continuous extension of the minimum thickness section is formed, stress dispersion effect is maximized. Additionally, if both sides of the diaphragm are processed to have symmetric curves, it may make machining relatively easy.

In addition, the flexible diaphragm unit 123 includes a first diaphragm element 123a and a second diaphragm element 123b which are joined together in the axial direction to form a space portion therebetween. The flexible diaphragm units 123 are respectively disposed at both flanges 110, which are joined with the power apparatus, along the axial direction.

In more detail, the flexible diaphragm unit 123 gets thinner from the hub unit 121 to the rim unit 122, and has a shape in reverse proportion to the square of a radius so that shear stress by torque is consistent in the entire diaphragm surface. The thickness is minimized at a certain point (the minimum thickness section) between the hub unit 121 and the rim unit 122, and then, the thickness is increased again toward the rim unit 122.

In correspondence to the shape of the flexible diaphragm unit 123, there are inflection points 1233 and 1234 existing at both sides in the axial direction. Positions of the inflection points 1233 and 1234 do not coincide with each other, and one of the positions is located outside in the radical direction relative to the other side.

As described above, because two inflection points are respectively disposed at both sides in the axial direction of the flexible diaphragm unit 123 and the two inflection points are located at different positions from each other, the power transmission shaft according to the embodiment of the present invention can alleviate stress concentration and improve fatigue properties. In this instance, if the length of the minimum thickness section Tmin is designed properly, it is possible to realize the optimum structure that stress concentration alleviating effect is maximized.

As previously described, in the detailed description of the invention, having described the detailed exemplary embodiments of the invention, it should be apparent that modifications and variations can be made by persons skilled without deviating from the spirit or scope of the invention. Therefore, it is to be understood that the foregoing is illustrative of the present invention and is not to be construed as limited to the specific embodiments disclosed, and that modifications to the disclosed embodiments, as well as other embodiments, are intended to be defined by the scope of the appended claims.

1-5. (canceled)

6. A power transmission shaft to connect a power apparatus, comprising a flexible coupling comprising a hub unit located inside in a radial direction, a rim unit located outside in the radial direction of the hub unit, and a flexible diaphragm unit located between the hub unit and the rim unit; wherein the flexible diaphragm unit comprises a minimum thickness section between the hub unit and the rim unit, the flexible diaphragm unit comprises a first contoured side at one side and a second contoured side at the other side in an axial direction, the first side comprises a first inflection point and the second side comprises a second inflection point; wherein the flexible diaphragm unit comprises a section shape that narrows from the hub unit to the second inflection point and that widens from the first inflection point to the rim unit; and wherein the first inflection point is formed at a different position in a radial direction relative to the second inflection point.

7. The power transmission shaft according to claim 6, wherein one of the first inflection point and the second inflection point is arranged outside in the radial direction relative to the other one.

8. The power transmission shaft according to claim 7, wherein a section between the first inflection point and a central line and a section between the second inflection point and the central line are formed symmetrically with respect to the central line between the first inflection point and the second inflection point in the radial direction.

9. The power transmission shaft according to claim 6, wherein the minimum thickness section is formed to extend from the first inflection point to the second inflection point.

10. The power transmission shaft according to claim 6, fwherein the flexible diaphragm unit is configured by a first diaphragm element and a second diaphragm element which are joined together in the axial direction to form a space portion therebetween; and wherein two flexible diaphragm units are respectively disposed at both two flanges, which are joined with the power apparatus, along the axial direction.
